(19) United States
(12) Patent Application Publication
(10) Pub. No.: US 2013/0263787 A1
(43) Pub. Date: Oct. 10, 2013

(54) ANIMAL INSTALLATION USER INTERFACE

(71) Applicant: Anders Nyberg, Spanga (SE)

(72) Inventor: Anders Nyberg, Spanga (SE)

(73) Assignee: Delaval Holding AB, Tumba (SE)

(21) Appl. No.: 13/993,400

(22) PCT Filed: Dec. 22, 2011
(86) PCT No.: PCT/SE11/51587

§ 371 Date: Jun. 12, 2013

Related U.S. Application Data
(60) Provisional application No. 61/428,544, filed on Dec. 30, 2010.

(30) Foreign Application Priority Data
Dec. 30, 2010 (GB) 1022107.5

(51) Int. Cl. A01J 5/00

(52) U.S. Cl. CPC A01J 5/007
USPC 119/14.03

(57) ABSTRACT

A control and monitoring system includes an interactive display that displays output information relating to the current status of operations in animal treatment stalls arrangement and operator input channels. The system displays a representation of the stall arrangement in which each stall is represented by a cell and in which the cells are displayed in a spatial layout corresponding to the layout of stalls in the stall arrangement. The system displays live video picture images of any animal present at that stall in association with corresponding represented cells in the interactive display. Video picture images may be available in connection with additional elements in an animal installation and may be displayed in combination with data associated with the element depicted in the video pictures and describing the current status of operations at the shown location.

The present invention relates to means for the monitoring and control of operations at an animal installation. In particular, the invention relates to a monitoring and control system for operations in an animal installation comprising a plurality of animal stalls. More particularly, the invention may relate to the monitoring and control of milking operations in animal stalls. In particular, the present invention relates to the control and monitoring of dairy milking operations in an installation comprising multiple milking stalls on a rotating platform.

The keeping of animals in installations in an industrial establishment has been transformed by the advent and expanded use of information technology. As a consequence, the control of animal related processes has developed such that a great many parameters relating to equipment can be controlled accurately and rapidly. In addition, the amount of information which is gathered concerning individual animals and parameters relating to their management has greatly increased. It has thereby resulted that control and management systems have become increasingly complex, both in terms of the variety of information which is handled and in terms of the number of variables which can be controlled.

On the other hand, certain aspects of animal management retain a great deal in common with traditional practices, especially concerning the physical environment and concerning the animals themselves. For those individuals who work within an animal management installation and whose task it is to operate animal management systems, there is a need to enable the monitoring and control of operations using sophisticated equipment even while providing a control system which is easy to use and easy to learn and which is amenable and effective for use in a technology unfriendly environment. A suitable system should offer users a maximum level of functionality and flexibility, while at the same time remaining easy to operate.

In patent application number WO01/17336, there is disclosed a graphical user interface for the monitoring and controlling of parts of a dairy farm system. An exemplary embodiment which is disclosed in WO01/17336 concerns the graphical representation of animal teats in a spatial relationship which corresponds schematically to the actual spatial arrangement of the teats. Another embodiment illustrates the positioning of control symbols or icons for certain elements in a milking installation such as gate opening/closing controls and manger positioning controls. The examples which are discussed relate to a milking operation which is being carried out on an animal at a single location.

It has been known to carry out automatic teat cup attachment using robot means which make use of remote teat detecting means in order to locate animal teats, determine their position, and attach teat cups in real time. Examples of detecting means which may be used include laser or infra-red or ultrasound devices. In WO2009/093967, there is disclosed the use of a so-called time-of-flight camera at an animal stall, which generates three-dimensional information of the objects in its field of view. The information may be numerically analysed to generate position information of the animal in the stall. The position information allows a teat cup attachment robot to adjust its approach to the animal in relation to the detected three-dimensional position of the animal. Also known, from WO2007/050012, is the use of camera means for producing images around the udder area of an animal which are numerically processed and analysed in order to detect the position of the udder in preparation for teat cup attachment.

In some animal installations, individual animal stalls are provided about the periphery of a rotary platform. An example of a rotary animal platform with animal stalls at its periphery and comprising a control system is disclosed in WO2009/093967, which relates to an automatic milking installation. In the arrangement which is described, multiple milking operations can take place at one time. Each milking operation on a platform typically starts and finishes at times which are staggered from the start or finish times of other milking operations on the same platform. Some milking platforms are large, and can thereby accommodate a large number of simultaneously occurring milking operations. Animals may be able to voluntarily access the platform and, having accessed the platform, they may or may not be permitted to be milked. Animals may receive feed, and any feed which animals are given may be provided in varying types or quantities, depending on the animal's needs. Leaving the platform may be obligatory or voluntary, and may take place at one or more designated locations. Some animals will yield more milk than others and some animals will be milked more quickly than others. The previously suggested solutions for creating input/output controls for animals being milked in individual stalls would lead, in the case of a rotary stall, to an information overload for operators. It is an object of the present invention to provide an input/output control system which allows simple, efficient and reliable monitoring and control of a rotary milking platform.

A control and monitoring system according to the present invention is defined in appended claim 1. Further preferred embodiments thereof are defined in subclaims 2-8. An animal installation according to the invention is defined in appended claim 9. Further preferred embodiments thereof are defined in subclaims 11-13.

The control and monitoring system of the present invention may in particular take the form of a graphical user interface capable of being implemented by a computer. It may comprise substantially software instructions stored on an appropriate physical support or in a suitable computer. Optionally, the control and monitoring system of the invention may include hardware elements such as a computer including control circuitry or input and output means for interactive use by an operator.

The system of the invention is intended to make it easy for an operator to monitor and control activities in an animal installation which comprises multiple animal treatment stalls. The stalls in an installation are arranged as a rotary animal platform arrangement which comprises multiple animal stalls about its periphery. Treatment stalls may include any type of animal stall, usually an enclosure of some kind, in which an operation is carried out in relation to an animal, such as feeding, or cleaning or milking. Operations carried out in a treatment stall designate activities performed in relation to a stall (such as e.g. cleaning the stall) or in relation to an animal at a stall (such as e.g. cleaning or milking the animal) and may in particular be carried out using automated equipment such as robots. The main use of the present system is envisaged to arise in relation to commercial animal milking stalls, although other applications are feasible.

The control and monitoring system of the invention is configured for displaying graphical information by means of a display. In some cases, the control and monitoring system may include elements of hardware such as interactive display means. Interactive display devices are preferred in the present context and include such known apparatus elements as a screen and keyboard, optionally with a mouse device, or touch-screen type display devices. Alternatively, any suitable screen type display may be used in association with known input means such as keyboard, dedicated keypad or control switch panel or mouse device associated with a screen type input panel such as a keyboard, keypad or control panel. Such an input/output means may be known generally as an interactive display. The control and monitoring system of the invention thereby typically operates in connection with an input/output module associated with one or more system control computers and optionally with one or more data storage and management computers.

The control and monitoring system will allow an operator to review the current operational status of the milking platform, while also inputting control commands or carrying out data entry or data correction in certain fields. Any display which displays output information relating to the platform or operations on the platform may also display one or more input channels through which control commands or data may be entered by an operator. In some embodiments, the system of the invention may comprise at least one display device which is for monitoring purposes only, in addition to at least one interactive display device of the system. A display-only device may be an interactive display device in which the input mode has been disabled, or it may be a display-only device with no input means. Input channels may be selectable input elements which are displayed for example in the form of icons such as control button icons or symbols or in the form of alphanumeric text entry fields or any combination of channel types.

As mentioned, a location in an animal installation where an animal may reside and where the animal may be treated may in particular be known as a stall. Any stall may suitably comprise an area which is large enough for an animal to reside. It may be surrounded by barrier or fence members, thereby separating neighbouring stalls from each other. It may be desirable to include restraining means for an animal at each animal stall. Restraining means could take the form of a body restrainer such as a neck lock or lock for another part of the animal's body or in the form of blocking means for the animal's body. Any restrainer or blocker or lock may suitably be associated with control means for automatic engagement or disengagement with the animal, thereby restraining or releasing the animal in a controlled manner from a stall. Stalls may be arranged in groups which comprise any suitable rotary platform arrangement.

According to the invention, the stalls are graphically represented in a display of the control and monitoring system by means of a representation of cells in a layout which corresponds approximately or generally or closely to the spatial layout of the arrangement of stalls in an installation, where the number of cells corresponds to the total number of stalls in the particular arrangement of the installation which is represented. In any case, the displayed layout of cells, as represented in accordance with the invention, corresponds recognisably to the layout of stalls in the arrangement of the installation. Any suitable cell shape may be used for representing a stall. Preferably, all cells are of an equal or approximately equal size, in particular, where the stalls which are thereby represented have a uniform or substantially uniform size.

In further aspects of the invention, each cell displays one or more pieces of information, with each piece of information being placed at an information display sub-location inside each cell. In general it is envisaged to provide one or more such sub-locations per cell. Each sub-location may display e.g. an information icon or symbol or a text field. According to the invention, in which a rotary platform is represented by the system of the invention, for each angular location of a represented cell about the periphery of the graphically represented platform, there is a unique position of one or more sub-locations.

According to the invention, video images captured at an animal stall are shown to users of the system via a said display means. The images from a stall are in particular shown via a display in association with the graphically represented cell which corresponds to the stall from which the video images are collected. The video images may be shown within a cell in a graphical display of all cells in an arrangement. Alternatively, video images from a particular stall may be shown in association with a corresponding cell in response to the selection by an operator of a corresponding icon in a cell. In the latter case, the video images do not interfere with a basic graphical representation of a stall arrangement using cells which contain information and possibly icons relating to the status and operations in a corresponding stall. When video images from a given stall are shown in a display, they may be shown in association with additional information relating to the stall, any animal present in the stall and any information relating to activities at the stall.

In many installations, multiple stalls are arranged close together so that visibility into the stalls can be inhibited. This situation can be made worse by the presence of ancillary equipment inside and around the stalls. In some cases, an operator would have to stoop down to the ground or look down from above in order to get a view of the operations taking place in a stall or in order to look into a stall without being exposed to danger from moving equipment or other hazards. By positioning cameras at key locations or by providing cameras which are movable into key locations, and by relaying and integrating the video images into a user interface system according to the invention, the oversight of an installation can be made more effective and also easier. The operator may be given a view of activities in a stall which would be difficult or impossible for the operator to obtain from a position near the stall itself.

In the present context, the term “video images” is intended to designate generally conventional analogue or digital picture images for normal viewing by an operator. These may be distinct from enhanced image information such as infra-red or three-dimensional images, which may present visible information in a format not generally suited to viewing images depicting a scene.

The purpose of the video images in the context of the present invention is to allow a maximum of information to be shown to operators, especially in case it should be required, without overloading the graphical user interface or control system which an operator uses. For example, it may become apparent, from a perusal of operational information which is displayed in the respective cells which make up a representation of a stall arrangement, that certain anomalies appear at a particular stall. Whilst information or warning symbols can be shown in any cell if necessary, to draw attention to a situation requiring attention, there may nevertheless be instances in which it is not apparent what particular problem or difficulty or impediment has arisen at a particular stall. In order to avoid the need for an operator or technician to present themselves at the stall in question, the operator of the system according to the invention may be provided with considerable additional information by selecting a video image view of the stall where there is a suspected problem.

The video picture images are in particular live images. The term “live” is intended to designate the images as being in real time, if necessary with a little delay such as system dependent delay. In order to limit the information processing capacity requirements of the operating system, it may be appropriate to use video picture images which have a low time-base, i.e. a low frequency such as 10 Hz or in some cases, one frame per second. In most cases, and where processing capacity permits it, the image frequency may have a more conventional level, such as of the order of 50 Hz-100 Hz or higher.

An operator may be made aware that video images are available in respect of a particular stall using any suitable means. For example, each cell corresponding to a stall for which video information is available may show a graphic symbol or a thumbnail type video image which a user may select using e.g. a mouse or touch-screen to reveal the full video picture image which is available for that stall. A suitable icon may for example be a camera icon of some appropriate recognisable type.

In general, the selection by a user of any particular displayed graphically represented entity, by means of the interactive display device, will reveal additional information concerning that entity. In this context, an entity may be represented by an icon, a piece of text, a number or a representation of a physical object. In particular, an entity may correspond to any piece of apparatus such as a robot or a stall or it may be an animal. In addition, any piece of text or information icon may be selectable to thereby reveal additional details. Hence, advantageously, in aspects of the invention, any icon or any text or number at a cell sub-location may be selectable by an operator from a display screen to reveal additional information concerning the selected icon, item or field e.g. selection of a cell may reveal additional information concerning the operations in the corresponding stall, while selecting an animal icon may reveal information concerning the animal in the stall, and selection of an information sub-location at a cell may reveal additional pieces of information related to the information shown at the selected sub-location of the relevant cell. Where a displayed icon representing a physical entity is selected by a user from a given graphical display page, there may in particular be shown live video picture images of that entity if they are available. The selection of a cell by a user of the interactive display device may in particular generate the display of additional information pertaining the animal and/or to the operation in a corresponding stall either as additional information in the platform screen view (i.e. as additional information displayed in combination with the platform representation view) or in an alternative view representing the selected cell in an enlarged, more detailed representation, containing a larger number of information fields and icons or symbols. Hence, selection by an operator, of a cell in a given screen arrangement, will reveal video images from a corresponding stall. Alternatively, a greater level of detail concerning a selected cell may be displayed as a cell-specific screen display, separate from either the platform representation or from a graphic representation of a cell or stall itself.

When showing video picture images of a given stall, it is intended in the present context to show images substantially showing a view containing a stall location without substantial additional or extraneous background items. The field of view of the video picture image which is displayed should extend around one stall only, the image thereby being recognisably, from the point of view of an observer, of one and only one stall. The image thereby displays animals or objects which are present at the stall, i.e. animals inside or entering/leaving the stall or objects such as robots which are operating at the stall or which are entering/leaving the stall or any operator which is in the stall or entering/leaving the stall or parts of the stall or platform construction. In other words, any physical entity of a sufficient size to be captured by the camera image resolution, which is in or at the stall, will normally be visible in a video image of the stall. This provides the advantage that when a single cell is selected by an operator, for viewing video picture images, the operator will instantly know that the stall in question is being shown and will thereby be all the more quickly able to determine whether something is abnormal, and if so, exactly which stall is concerned. An appropriate camera layout is required in order to ensure that a single selection by a user will reveal only a single location in the corresponding video images. For example, individual cameras may be established at each selectable location, or movable cameras may be employed which can be moved to a predetermined location on demand, corresponding to a location or to a physical entity which is selected by a user. In some embodiments according to the invention, data or information concerning operations at an animal stall or concerning the animal present at a stall, or concerning a physical entity such as a robot, may be shown combined with a video image of the stall or animal or physical entity. The information may for example be overlaid on a part of the video image.

In certain embodiments of the system of the invention, in order to ensure that maximum information is provided to a significant extent throughout an arrangement or installation, there may be video images available for at least half the animal stalls at any multiple stall arrangement, either using fixed cameras at each video location or by using movable cameras, capable of moving to designated locations where images are to be collected. In other embodiments, at least one quarter or at least one third or at least two thirds of animal stalls may be individually viewed by video means. Individual video images of a given stall are distinct from general area surveillance cameras which may operate around an installation, showing overall views of multiple locations.

In particular embodiments, those stalls for which video images are provided by the system of the invention include at least stalls where an intervention or treatment is performed on an animal in the stall or on the stall itself. Examples include teat cup attachment by hand or by means of an automated system such as a robot. Since teat cup attachment initiates a milking operation which runs for some time after the attachment step, it may be of particular importance to provide maximum information concerning that intervention, especially since it involves several steps, any of which may be susceptible to be unsuccessful. Other examples include cleaning of an animal or stall, milking an animal or feeding an animal.

Video coverage of animals during other operations such as during milking may also be desirable. It is known, for example, that during milking, animals sometimes kick off the teat cups which have been attached. Other, unpredictable and unlikely difficulties may arise during the course of milking, especially when it is carried out on a large scale and over a prolonged period of time. Not all eventualities can be provided for by the use of dedicated sensors and warning signals. An operator's attention to a particular cell might be drawn by an unusually low milk yield or by an unexpected set of parameters. By selecting the cell and receiving video coverage of the corresponding stall, an operator may be able to ascertain either that all is well or that action is required. This can be done without loss of time and can avoid the need for further possibly unnecessary investigation.

In case of a moving stall arrangement such as a platform, a stall location may in particular correspond to a position which is occupied by a stall for a period of time.

In the present context, a rotating animal platform may comprise a circular or generally circular annular platform associated with drive means which may drive the platform in rotation in increments or at a slow, more or less constant speed. The platform rotation speed may in any case be adjustable in accordance with circumstances e.g. in accordance with the identified animals which are currently in place on the platform. The rotation of the platform may be driven by any suitable drive means and controlled by any suitable control means, in particular, drive control means associated with the system control means. The periphery of the platform is understood to designate that part of the platform on which animal stations are provided and will generally be located radially away from the centre of rotation of the platform, at, nearby or adjacent to the outer perimeter of the platform. Advantageously, access by operating personnel or by machinery to the animals on the platform is possible from a position inside the central area within the rotating annular platform, although in some designs, access to animals may be from outside the perimeter of the rotating platform.

Where the arrangement which is graphically represented is a rotary platform, each cell may be represented as a sector of a generally annular platform arrangement. In another aspect, each cell is displayed as a window, with respective windows being arranged in an annular or approximately annular array. In another aspect, the platform is represented as a circular annular body divided into a number of cells of equal or approximately equal size. As the platform rotates, the graphical display may be periodically updated so that the annular graphical representation on the display corresponds at all times closely to the current position of the cells on the platform.

The rotation of the platform may be periodic or continuous, and the rotation of the platform representation may represent the rotational motion of the platform in any suitable manner. Continuous motion may be of constant or variable speed. In preferred embodiments, the movement of the platform is represented by the periodic updating of the position of each cell in the graphical image representation of the platform. In one aspect, each cell is represented as a sector of a generally annular platform arrangement. In another aspect, each cell is displayed as a window, with respective windows being arranged in an annular or approximately annular array. Alternatively, any suitable cell shape may be used for representing a stall. In another aspect, the platform is represented as a circular annular body divided into a number of cells of equal or approximately equal size. As the platform rotates, the graphical display is periodically updated so that the annular graphical representation on the display corresponds at all times closely to the current position of the cells on the platform. The rotation of the platform may be periodic or continuous, and the rotation of the platform representation may represent the rotational motion of the platform in any suitable manner. Continuous motion may be of constant or variable speed. In preferred embodiments, the movement of the platform is represented by the periodic updating of the position of each cell in the graphical image representation of the platform.

Accordingly, during use of the system according to embodiments of the invention concerning a rotary platform, an operator supervising the activities on an animal platform will at all times during operation of the platform have a correspondence between the control system display and the current position of all the stalls on the platform, allowing the operator to easily and quickly monitor the progress of any and each of the contemporaneous operations in the respective stalls on the platform.

According to the invention, the displayed information in each cell will provide a quick and ready reference for an operator, allowing any anomaly in the running of an operation to be spotted and acted upon. If necessary, the operator can use an input channel for adjusting information or parameters in any stall or robotic unit in order to modify current data relating to a particular operation or in order to make changes to operating parameters. At all times, the operator will be able to maintain a correspondence between the cell upon which adjustments are being made and the animal occupying the corresponding stall, thereby ensuring the best possible effectiveness during operation. This aspect may be of particular importance having regard to e.g. safety issues, for example, when an agitated animal is observed, its stall control location (i.e. its displayed cell) can be immediately found. Or, where an animal's current exhibited performance characteristics in a given cell appear out of the ordinary, then the animal can easily be seen at its corresponding location on the platform so that a rapid resolution of a possible problem can be facilitated. In all cases, the high level of correspondence between the displayed graphic image and the stall arrangement, as well as the simplified information display allows fast, safe, accurate and effective monitoring and control. Moreover, the availability of video picture images further adds to the ease of use and effectiveness of the system.

In addition, in an arrangement of stalls corresponding to a rotary platform on which stalls are provided, the entrance and exit of animals onto the platform may be subject to individual video surveillance at a corresponding entry or exit stall location. In certain cases, it may be preferred to additionally provide video coverage at a stall location which is intended to be vacated, after its rotation past an exit location. Such a stall location may correspond to an intentionally vacant location in between an exit and an entry location on a platform. In case an anomalous indication exists, in relation to the status of an intentionally vacant stall due to its location between an exit and an entrance, e.g. as to whether it is occupied or vacant, then an operator may elect to receive video images from the location in question in order to ascertain a true situation in order to provide any necessary rapid intervention, or in order not to intervene unnecessary.

According to the invention, real-time status information, i.e. current updated information, relating to operations on the platform is displayed inside a cell by the interactive display device. The term: ‘real-time’ in this context is intended to refer to displaying information concurrently with events as they occur. The information may be displayed in the cells as well as in other parts of the display. Real-time status information may comprise any relevant information, in particular it may comprise current information which is updated such that it corresponds to actual measured process parameters or it may include information concerning a piece of apparatus or an animal. These parameters may in particular be any operating parameters or measures associated with the process in operation at the stall in question. According to a further aspect of the control and monitoring system of the invention, each cell which is included in the graphical representation may in particular exhibit status information relating to one or more parameters of an animal management process. Status information may be “real-time” information in the form of a progressively and frequently updated parameter measurement, such as e.g. current milk yield. It may also be information which is subject to periodic updating such as e.g. a cow number. A stall number represented in any cell may form part of the displayed information in the cell although it may be subject to less frequent updating because it consists of pre-set information. Status information parameters may also include animal parameters of an animal which is present in a relevant stall and may include animal specific data retrieved from an animal data bank. The data may include historic and current data specific to a given animal or herd.

In a further embodiment, each cell which is included in the graphical representation exhibits each process parameter at a respective discrete sub-location inside each cell. Each cell typically comprises an identical number of information sub-locations although this may not be immediately apparent from the cells themselves, because not all the information sub-locations may be occupied by a displayed piece of text or symbol or icon or text input prompt. As mentioned, a process parameter which is displayed in any cell may in particular be any piece of information relating to the stall which corresponds to the particular cell, such as the operation being carried out in the stall or the animal or equipment in the stall. In the case of a milking platform, a useful process parameter which may be exhibited is the animal identification number stored in a transponder which is worn by the animal. In the case of a cow, this may be the animal's cow number. In many cases, the animal also wears a visible physical record of its identification number. The correct identification of animals at the platform stall is important because it may be relevant for a teat cup application robot or a teat treatment robot such as a teat finding and preparation robot. The constant correspondence between the position of a stall on the platform and its representation as a cell in a display makes it easier to spot any such discrepancies. A corrective measure could be taken by, e.g. selecting the alphanumeric transponder field in the relevant displayed cell and entering a corrected number.

Another example of a process parameter which may be displayed in a cell is the current milk yield of an animal. As each animal progresses around the platform, towards an exit location, a certain approximate level of milk yield can be expected. When an operator reviews the display representation of the platform, it may quickly become apparent that a surprisingly low yield is being generated, having regard to the relative position of the cell around the graphic representation. Action may thereby quickly be taken, either to monitor the animal in question more closely, to see if it is unwell, or if the equipment is malfunctioning or incorrectly applied. Additional information to be displayed in a cell may for example include some or all of: expected yield; animal weight; animal age; teat status (for each teat, an indication whether or not it has a teat cup attached); transponder serial number; error status; error code; warning message; information prohibiting the attaching of a teat (e.g. if something is wrong with it); other information message.

In general, all cells which are represented will preferably have an identical size and outline shape. In embodiments of the invention, the information sub-locations in each cell may be fixed. In such cases, all displayed cells will appear identical, but for the content of the information which is displayed in each cell. In order for any alphanumeric text to remain horizontal and clearly legible as a cell progresses around the periphery of the annular graphical representation, the cell's aspect in relation to the centre of rotation of the platform representation will be adjusted for each position about the periphery of the representation of the platform. For example, each cell may suitably be represented as a circle, ellipse or triangle or rectangle, such as a square.

According to still further aspects of the control and monitoring system according to the invention, the interactive display may show a graphical representation of the stall arrangement itself accompanied by the representation of one or more units which perform operations on the animals in the stalls. An unit may in particular be an automated unit such as a robot. In a milking installation, such a robot may be e.g. a teat attachment robot, a teat locating robot, a teat spraying (disinfecting) robot or a teat-cleaning robot or other treatment robot. Units which perform operations on the animals in stalls may include a stall-cleaning apparatus or sensor devices intended to provide triggers in case of safety alerts or technical malfunctions. In particular, any representation of a unit or such as an automated unit may exhibit real-time status information relating to operations being performed by that unit. Advantageously, according to aspects of the invention, each graphically represented entity in the interactive display may be individually selected by a user to thereby reveal additional status information relating to a stall corresponding to a given cell or to operations being performed by a particular unit. Additional information may be shown in a separate screen display view relating to the cell or to the unit which is selected. It may include a two- or three-dimensional image of the cell or unit. Additional status information relating to a stall or to an operating unit may be shown in a display screen in addition to the graphical annular representation of the stall arrangement or in a separate screen image from said graphical annular representation of said arrangement. The control system and its interactive display may thereby allow a cascade of information views, with any view allowing a selection of additional information to be shown in further views.

Further features and advantages of the system of the present invention will be explained with reference to examples and to illustrations of certain examples of various aspects of the invention and of an animal management system. Examples are provided for information and illustration purposes and are non-limiting as to the scope of protection.

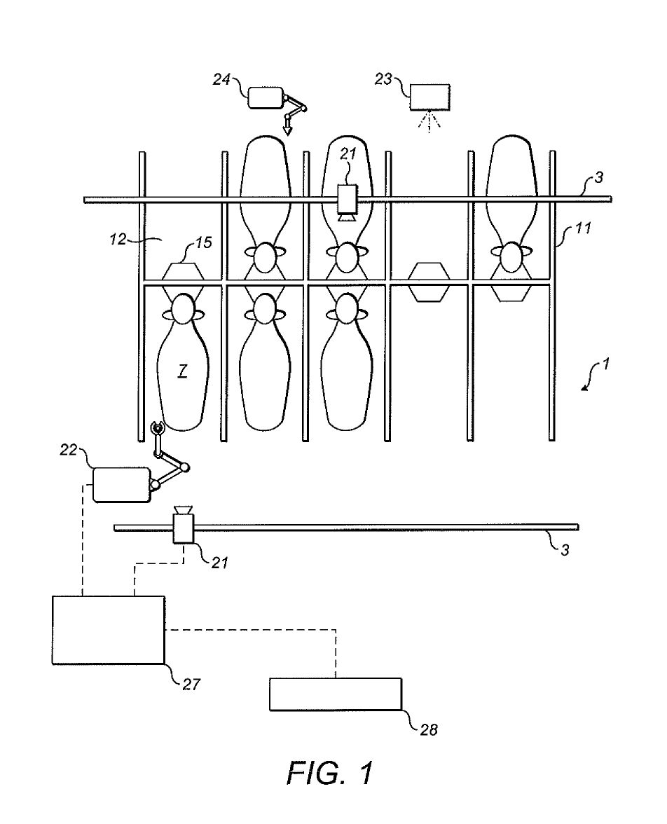

FIG. 1 shows an example of a not claimed animal stall arrangement which is used for milking.

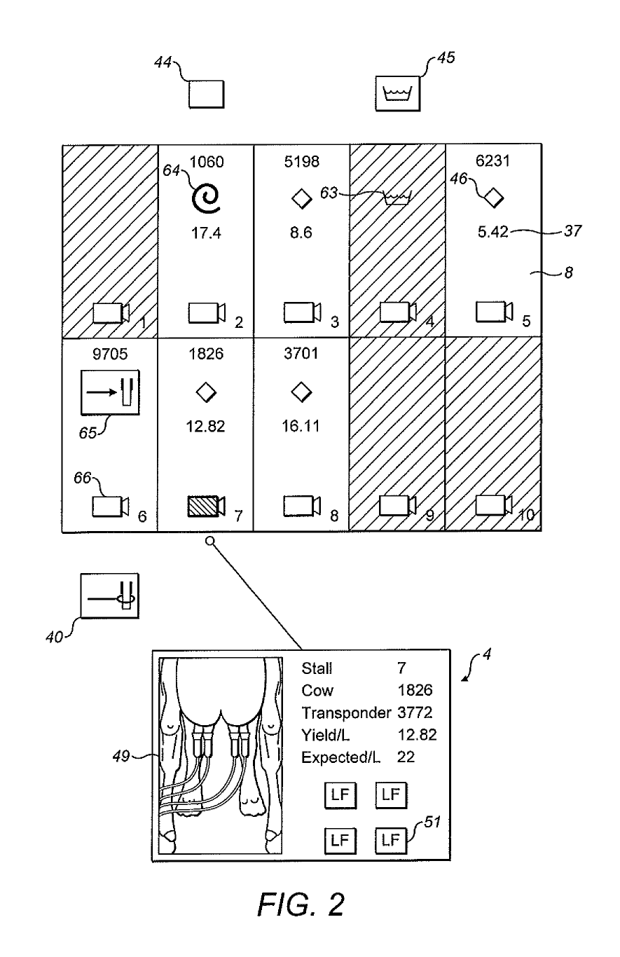

FIG. 2 shows an example of an alternative graphical representation of a not claimed animal stall arrangement similar to that shown in FIG. 1.

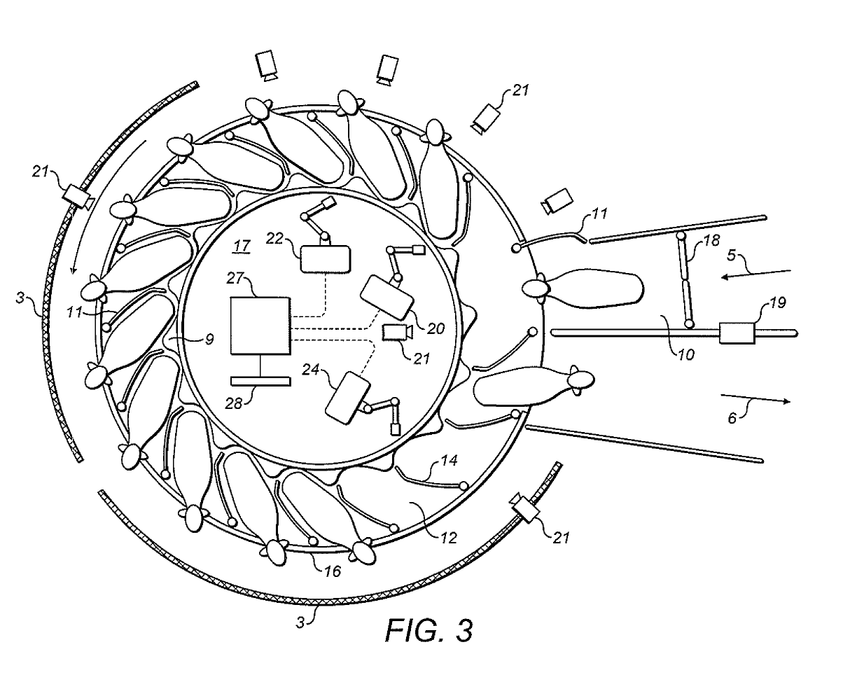

FIG. 3 shows an example of a rotary platform stall arrangement.

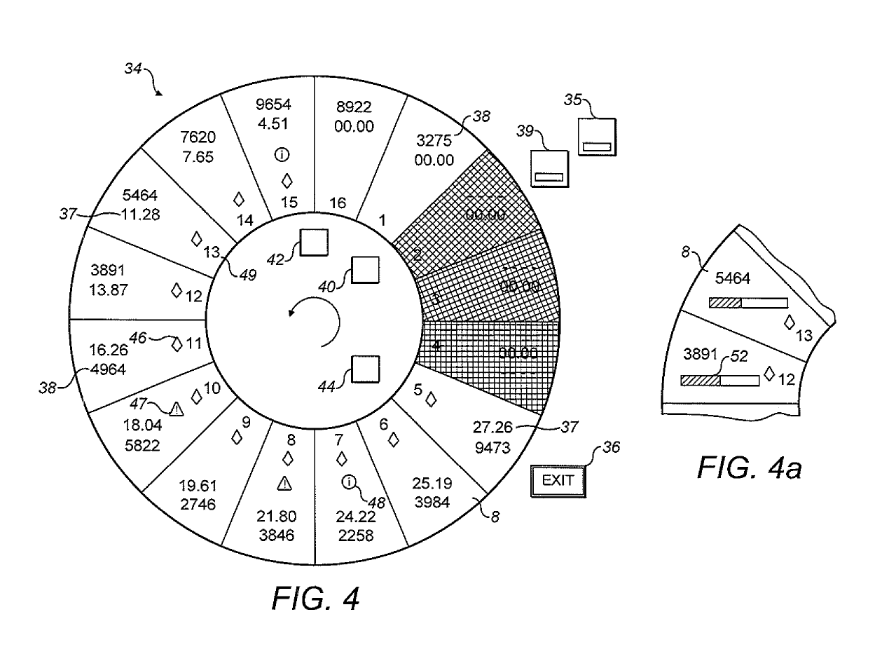

FIG. 4 shows an example of a graphical representation of a rotary platform stall arrangement.

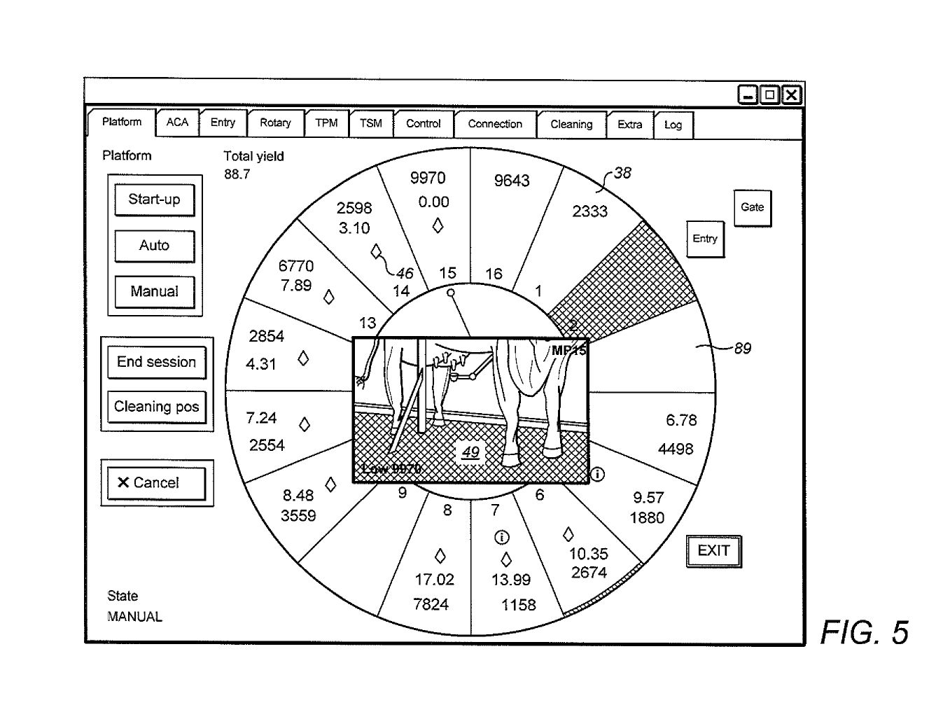

FIG. 5 shows an example of a screen display showing video image detail concerning a stall corresponding to a represented cell.

A simplified view of a not claimed animal stall arrangement 1 is shown in FIG. 1. The arrangement 1 comprises a plurality of individual stalls 12 separated by partitions in the form of barrier elements 11. The arrangement 1 may in particular form part of a larger installation which comprises additional groups of stalls (not shown). In FIG. 1 the animal treatment stalls 12 which are illustrated are milking and feeding stalls. A robot 22 for attaching teat cups to animals is shown and, in the example which is illustrated, the robot 22 is capable of moving to a relevant stall for carrying out an attachment operation. The robot 22 may also perform teat cup removal and cleaning, although other dedicated robots may be used for these and other tasks such as stall cleaning. In the not claimed arrangement of FIG. 1, animals having been identified and requiring treatment such as milking are guided or lured into stalls 12 where they find food in a trough 15. Whilst many pieces of apparatus for performing animal related operations are largely automatic, there is nevertheless a need to maintain supervision of animal installations because of the possibility of unexpected system requirements or malfunctions of various types. Where animals are involved, there is always the possibility of harm or discomfort to the animals from inappropriate situations, in connection with an animal installation. Remote supervision and control using appropriate control and monitoring systems allows for a reduction in personnel. In order to enable a remote operator to gain maximum information concerning activities at the individual animal stalls, video cameras 21 are installed at the stall arrangement. These may be provided at fixed locations, such as at each stall and possibly also at any additional locations where critical operations are carried out. In the example of FIG. 1, the cameras 21 are shown as mobile cameras which are able to move along a guide 3 to more than one location in order to collect and relay images. The location of a movable camera 21 may be determined following a request for image information made by an operator via a control and monitoring system. The operations of automated equipment illustrated in FIG. 1 may be controlled by a computer type control device 27. The control device 27 may in particular co-operate with a display 28 for providing an operator with process data and information, including real-time information concerning operations at the animal installation.

The display device 28 will be associated with interactive means such as a mouse or keyboard, or it may be a touch-screen, allowing an operator viewing the display to receive information concerning the processes which are taking place at the animal stalls and to intervene in the processes if necessary. When a large number of stalls are included in an arrangement 1, and in particular when a large number of stalls is occupied by animals, the handling of information may be critical, if it is to be possible for an operator to maintain an overview of progress being made. Hence, the information which is selected for presentation and the manner of presentation can be of significant importance in the effectiveness of the control system. In some cases there may be provided more than one display device associated with any given control and monitoring system of the invention. In particular, there may be provided at least one display device which is interactive and at least one display device which operates in a read-only mode. This would for example enable remote supervision of a stall arrangement while leaving control interventions in a process at the stalls to personnel at or nearby the stall arrangement, which may be utilising an interactive display device located at or nearby the stalls.

In FIG. 2, there is shown a simplified representation of a not claimed stall arrangement which may be generated by a control and monitoring system according to the invention. Stalls 12 as shown in FIG. 1 are each represented by a respective cell 8, in a spatial layout on the display 28 which corresponds to the stall layout in the installation. By way of example, those stalls which are occupied by an animal are shown with a light colour background, while the vacant stalls are shown with a darker, shaded background. An animal number 38 is also shown in stalls which are occupied. In the stalls where milking is being conducted, a milking symbol 46 is displayed. A teat cup attaching robot 22 is represented by an icon 40, while a stall cleaning robot 23 is represented by an icon 45. Additional information icons may be displayed for a variety of activities, including but not limited to teat cleaning 64 and teat cup attachment 65. Video image icons 66 are shown at each location for which images may be obtained. In order to view more information concerning activities at a given stall 12, an operator may, for example, select the corresponding cell 8 using any appropriate means such as a mouse, keyboard or touch screen. Accordingly, the displayed representation of the view of the not claimed stall arrangement 1 may be enhanced by displaying additional information relating to a particular stall as shown in the window 4. In some cases, the control and monitoring system may display video images along with the additional process information in the window 4, as shown in the example of FIG. 2. Alternatively, video image information may be displayed on demand by an operator by selecting a video icon 66 in a relevant cell. When images from a given cell are selected, a display may show a link between the video image and the cell 8 (stall 12) in question and/or the video camera icon 66 in the selected cell/stall may be highlighted in a different colour than the others. In the case illustrated, the camera icon 66 in stall 7 may be highlighted in order to give information to a viewer that the video images which are currently displayed are those from stall/cell number 7. As an alternative, the video image window 4 may be superposed on a part of the displayed stall layout. In each case, the video images 45 may be collected by a camera 21 located at the relevant location, or by a camera which is mobile and which is controlled to move to the required location along a guide 3. In a still further alternative, a thumbnail video image view (not shown) of a location may be displayed at the relevant corresponding location in the display representation of the stall arrangement. By selecting the thumbnail view in a given cell 8 or at a given location, a larger video image window may be shown in the display 28. In certain embodiments, the detailed process parameters relating to a given stall may be displayed overlaid on the video picture image which is displayed. Detailed process parameters may for example include some or all the parameters illustrated in the box 4 in FIG. 2 and may also include additional parameters.

The animal management platform which is shown in FIG. 3 comprises a rotary platform 14 surrounded on its outer circumference by a barrier 16. The illustrated barrier 16 is a stationary barrier which is interrupted at an entrance area 5 and an exit area 6. More entrance or exit areas could be provided as a matter of choice. Alternatively, the entrance or exit areas could be configured larger than illustrated in order to allow, for example more than one animal to access or leave the platform simultaneously. In another alternative arrangement, the barrier 16 could be movable around the external circumference of the platform 14 and could be articulated at each stall for permitting opening and closing of the stall thereby allowing animals to enter or leave a stall. An internal perimeter of the platform 14 in the form of a railing 9 prevents animals from leaving the platform in a direction towards its centre. In certain embodiments, a feed manger (not shown) may be provided in each stall 12, which may help to entice animals to enter the stalls 12 on the platform as well as providing animals with required nutrition.

The rotary platform 14 is divided into a series of neighbouring stalls 12, arranged around the periphery of the platform 14. Each stall is separated from its neighbouring stalls by a movable barrier 11 which defines the width extent of each stall in a generally circumferential direction. In the example illustrated, each stall 12 is designed to be occupied by a single animal. The positions of each movable barrier 11 are set up so that an animal is slightly restrained when it occupies a stall 12 when the movable barriers 11 at each circumferential side of the stall 12 are in a closed position. In the example of FIG. 3, the stalls are shown arranged on the platform in a so-called herringbone arrangement. Alternative arrangements include a tandem arrangement in which the stalls are longitudinally aligned parallel to the circumference of the platform or a parallel arrangement, in which the longitudinal direction of each stall is radially aligned about the platform. In all cases, animals are positioned at successive locations about the periphery of the platform 14.

The platform 14 which is illustrated has the shape of an annulus, i.e. of a circular ring. At the centre of the platform there is a central region 17 within which are shown various operating units which form part of the installation. Operating units may appropriately also be located outside the outer periphery of the platform. The location of operating units inside or outside the platform may depend upon the arrangement of animals on the platform (i.e. tandem vs. parallel or whether the animals face inwards or outwards). Operating units 22-24 may include electromechanical units which carry out operations on animals or on the platform. Other operating units may include control system elements which interact with the platform, with the electromechanical units and with an operator and which may be linked to information databases. A control system element is illustrated at 27, with a display element at 28. The control element may be a computer or more than one computer and is shown having a communication link to each of three illustrated operating units 20, 22 and 24. Where the platform forms part of a milking installation, the unit 20 may be a robot for locating and preparing an animal's teats for milking, e.g. by placing a cleaning and stimulating device on the animal's teats. The unit 22 may be a robot for placing a set of teat cups on the teats of an animal for milking, while the unit 24 may be a post-treatment robot for disinfecting teats after milking has been completed. Other animal management operations may appropriately be performed on a platform, in which case the operating units may have alternative functions.

The entrance 5 is provided in the form of an entranceway with barriers at each side and a control gate 18 with an identification receiver 19. An animal wearing a transponder passing along the entranceway 5 in the direction of the arrow is detected by the receiver and identification device 19 and, if the animal is permitted to enter the platform, then the gates 18 will be opened in order for the animal to pass into a buffer area 10 before it can move into a free stall 12 on the platform 14 via an open movable barrier 11. If the animal is not permitted to enter the platform, then an exit gate (not shown) may allow an animal to pass out from the entrance 5 without passing through access gates 18.

After passing the identification receiver 19 and the gates 18 and after entering the platform 14, the presence of an animal in a stall 12 of the platform 14 will be registered in the control system 27 of the platform. During each animal's stay on the platform 14, its presence will be visible in a displayed representation of the platform in an interactive display device 28 which is associated with the control system 27.

The platform which is illustrated in FIG. 3 is provided with video image cameras 21 for capturing and relaying local images at various locations about the platform to operators via the control system 27 and display 28. The cameras 21 are connected with the control system 27 using any appropriate control connection means, including wired or wireless connections (not shown). Connection using a TCP/IP ethernet link may also be envisaged. As in the example of FIG. 1, the cameras 21 may be fixed or mobile. In some cases, there may be provided at any given installation or stall arrangement, a combination of both fixed and mobile cameras. For example, it may be considered that certain locations are essential to be provided with ongoing camera coverage, while other locations can be covered adequately using one or more moving cameras. Where moving cameras are provided, these may be controlled to move along a guide 3, such as a rail, to respective desired locations. Camera movement may be achieved by means of an actuator such as an electric or pneumatic motor. In some embodiments, cameras may be in fixed relation to the platform, for example, mounted to an outer rail of the platform, to thereby rotate with the platform. When video images are requested by a user for a particular location, the control system 27 may operate the mobile cameras 21 such that they are moved to the predetermined position along the guide 3 which corresponds to the desired location for which images are requested. In some cases, fixed cameras may be mounted capable of performing a swivel motion such that they can provide video images of a wider area including more than one specific stall location if necessary. In the example of FIG. 3, it may be beneficial for the camera 21 which is shown located within the platform nearby the entrance and exit 5, 6 to be mounted on a swivel and thereby to be capable for supplying images of a relevant stall 12 at an animal exit location 6, an animal entrance location 5, and advantageously also a position between those two stall locations, normally vacated. In case an animal should be present at the position immediately between an exit 6 and an entrance 5, then this would likely create an emergency situation in which, for some reason, the animal has not succeeded to leave the platform as intended. In some embodiments (not shown), the camera guides 3 may overlap and may be provided in parallel, so that more than one camera can be moved to a particular location. This may be necessary in particular where it is intended to operate the video image system using more than one operator display terminal 28, with more than one operator working simultaneously supervising operations at an installation. Alternatively, it may be possible for a monitoring and control system according to the invention to display more than one set of video images concurrently. Hence, two or more guides 3 combined with cameras 21, may be positioned in parallel about all or parts of a stall arrangement. For the avoidance of doubt, cameras 21 at a stall arrangement 1 may be fixed, fixed and swivelling, or movable along a linear guide 3 or they may be comprised of any combination of the three types of cameras. In some embodiments (not shown in FIG. 3) additional cameras may be positioned fixed, movable or swivelling above parts of a stall arrangement such as entrance or exit areas or above treatment stalls. In some embodiments, cameras may be positioned only at locations where robotic operations are performed on animals.

Among the advantages arising from this described use of video picture image cameras 21 it is found that, in many instances, better views of the animal operations can be obtained than could be gained by personnel, especially due to obstruction by equipment and hazards from moving parts and from general operational aspects.

FIG. 4 shows an example of the graphical representation 34 of a rotary platform which may have a layout somewhat similar to that which is illustrated in FIG. 3. In the graphical representation 34, each stall 12 on the platform 14 is shown as a cell 8 flanked on each circumferential side by neighbouring cells which represent neighbouring stalls. The platform 14 may be represented in a generally annular shape as shown by way of example as a circular annulus in FIG. 4, although other annular shapes may be envisaged depending e.g. on display screen space requirements. The annular shape of the graphic representation of the platform may thus be described as being ring-shaped, with the ring shape being a circular or generally circular appearance. For example, the annular shape may have the general outline of a polygon such as a rectangle or hexagon or octagon or any approximately circular, irregular shapes. A circular shape as shown in FIG. 4 may be preferred because it provides a close resemblance to the general shape of a rotary platform. The shape of the cells may also be selected in accordance with preferences such as the type of information to be displayed. The cells 8 shown in FIG. 4 have the outline of sectors of an annulus. This shape provides the advantage that it makes maximum use of the available space within the annular representation of the platform. A possible alternative, shown by way of example in FIG. 4 leaves more redundant space around the cells, although it provides the advantage that the position of the various information display fields in each cell is unchanged irrespective of the relative rotational position of the cell about the origin of the annular representation.

Also shown in FIG. 4 are operational unit icons 40, 42 and 44 which, in this case, represent the operational units shown in FIG. 3. Entrance 5 and exit 6 are represented by respective icons 35, 36 which may display status information by means of symbols, e.g. signalling that the entrance or exit station is occupied by an animal or that it is free. Also a buffer area 10 may be represented by an icon 39 which also may display via a symbol whether it is occupied or vacant. Other appropriate indications may be included in the entry or exit or buffer icons, such as, for example, the number of animals (cow count) having passed through the given location after any given start time of the platform. If a user selects any entity, such as an icon or cell 8, from the display illustrated in FIG. 4, then additional information relating to that entity, i.e. to the apparatus or animal which it represents, may be displayed in a separate display or in a portion 4 of the display screen which is illustrated in FIG. 1. Where video images are available in connection with a location or with a piece of apparatus such as a stall or a robot which is represented in a display representation, then selecting the represented entity, shown as a cell or as an icon, may generate, together with information relating to that entity, a video image display of the entity or location in question. In some embodiments, video images associated with an entity or with a location may be viewed by selecting a dedicated video image icon 66 associated with the represented item which is of interest.

An arrow at the centre of the platform graphic image in FIG. 4 indicates the direction of rotation of the platform. As the platform 14 is rotated to move the stalls 12 progressively onward, so the positions of the respective cells 8 may be updated. Any appropriate movement increments may be utilised. In the example shown, there are sixteen stalls 12, each represented by a cell 8. When the platform is rotated through one sixteenth of a circle, the respective cells 8 in the displayed platform image 34 may be updated, thereby keeping the overall appearance of the image unchanged with the exception that the information displayed in each cell is moved along around the image periphery by one increment into the immediately adjacent neighbouring cell. In embodiments where cells are all identical and where the platform is moved in increments which correspond to a stall width, the platform movement which is replicated by the graphic display will appear to consist only of the progressive shifting of the displayed content of each cell from one cell to the next.

The various pieces of information which are displayed in each cell 8 may be updated periodically according to the same frequency as the updating of the cell position or they may preferably be updated more frequently. Preferably, all pieces of information or symbols which are displayed may be updated in real time or as near as possible to real time, i.e. so that the information remains current. Hence, as soon as milking commences in a stall 2, the symbol 46 may appear in the cell corresponding to that stall. Alternatively, when milking commences in a certain stall, the corresponding graphic cell display may for example present a different background colour or may present a shading background in place of a clear background. As soon as an identified animal is confirmed to have taken up its position in a stall 12, relevant stored information for that animal may be retrieved by the control system 27 from a data bank and some of it may be displayed in the relevant cell.

In some cases, such as where historic teat positions are stored for individual animals, the teat position information is utilised by the attachment robot 22 and the preparation robot 20 although it may not necessarily be displayed. More useful information concerning teat cup attachment may be displayed to the user in a more user-friendly form than by the indication of a set of co-ordinates. An example of a manner in which teat information may be displayed during milking is illustrated by the teat icons 51 in FIG. 2. Each teat is shown in a box its appropriate position relative to the other teats (Left Front; Right Front; Right Rear etc.), with each box being of one shade when a cup is currently connected and of another shade when no cup is connected. The display thus allows an operator to easily note whether all cups are attached and if not, which cup is missing. In an alternative embodiment of this display icon, the respective shades of each of the boxes corresponding to a teat may be changed according to whether or not a teat is considered to be milkable.

In the arrangements which are illustrated in FIGS. 2 and 4, the information which is displayed in each cell is essentially the same and concerns a milking process. It comprises on one hand an identification number 38 of an animal in the corresponding stall, and an indication of that animal's current milk yield 37. The stall number 49 to which the displayed cell corresponds is also shown. Also shown, where applicable, is an icon 46 indicating that an animal is present in a stall and that milking has commenced for that animal.

Stalls in which no animal is present may be indicated in a different background shade or colour (see stalls 2, 3 and 4 in FIG. 4 or stalls 1, 4, 9 and 10 in FIG. 2). In addition, a selected specific background colour may be used for any cell to denote a respective special status of the cell such as “disabled”, or “defective” or “requiring cleaning”. Examples can bee seen in FIG. 2, where stall number 4 is shaded because it is undergoing cleaning. A cleaning icon 63 is additionally displayed. By clicking on the cleaning icon 63, additional information concerning the nature of the cleaning and its status may be displayed, as well as video images where applicable. As an alternative embodiment, an unoccupied stall may be shown as a completely blank cell.

Alternative exemplary symbols which denote special indications concerning an animal are designated by numerals 47 and 48.

In the case of the milk yield which is displayed in each cell in respect of each animal being milked, an alternative to the display of the yield in alphanumeric form includes the display of the milk yield as a progress bar 52 (FIG. 4a). According to this embodiment, shown by way of example at FIG. 4a, the outline of an elongated rectangle may be displayed in each cell, representing a zero quantity of milk yield from the animal occupying the corresponding stall. As the animal is milked, the rectangle outline is shown progressively filled up, mapping the proportion (e.g. percentage) of milk yielded in relation to the expected milk yield. As such, in the case of a milking platform, a quick glance at the display of the representation of the stall arrangement will enable an operator to easily see if any cell is not in accordance with the stage of progression of its corresponding milking operation. Any cell in which an animal's milking is progressing too slowly will immediately be visible as an anomaly in relation to its neighbours in the graphical representation. If many progress bars are showing a low level of milk yielded, in relation to their relative progress around the circle, then this may indicate a general defect in the milking equipment. Accordingly, in embodiments of the present invention, the milk yield of an individual animal may be displayed in a cell by a progress bar 52. In embodiments of the invention, the display of a progress bar 52 in any cell 8 may be withheld until the milking process of the animal in the relevant stall has commenced.

According to aspects of the invention, when a displayed cell 8 is selected by a user, relevant current information relating to the animal in the corresponding stall, including video images where applicable, and relating to current process parameters may be displayed in an area of the screen showing the platform representation 34 or in a separate screen (not shown). Special indications which are signalled by the presence of symbols or icons may also be displayed following selection of a given cell. Window 4 in FIG. 2 provides an example of how additional information concerning an animal and the current status of a milking operation may be displayed following the selection of a cell 8 from the graphic representation of a stall arrangement 1.

The space required for displaying certain pieces of information may vary, depending on the information. For example, the number of digits needed for any given parameter display may vary. In the example shown in FIG. 2, the pieces of information which are displayed at each cell 8 are each positioned at a defined sub-location in the cell. The choice of the sub-location in a cell where a piece of information is to be displayed may thereby be dependent upon the amount of space available at that sub-location. The space available at any sub-location may depend upon the proximity of other sub-locations and also upon the shape outline of the cell itself. For ease of use, in particular where stall locations are dynamic, such as on a rotary platform, alphanumeric information which is displayed should be kept horizontal, irrespective of its position around the platform image. Thus, in the case of cell number 16 in FIG. 4, the available space for an alphanumeric parameter to be displayed is greatest at the top portion of the sector, where the cell is at its widest. That corresponds to an uppermost location in relation to the remaining sub-locations in that cell at that position. Smaller symbols or icons, and shorter text fields may be displayed at sub-locations which lie below of the uppermost location, where less cell width is available. Hence, the information which requires the most text space, in this case, the animal identification number, is displayed at the uppermost part of the cell when it is at its top position around the graphical image, above pieces of information requiring less space. On the other hand, for a cell located at the bottom of the platform representation, such as cell number 7 or 8 in FIG. 4, the greatest width is available at the lowermost part of the cell, below all other sub-locations in that cell.

As can be seen from FIGS. 3, 4 and 5, as any cell 8 progresses about the annular representation 34, the positions of the sub-locations relative to the cell and relative to each other may be made to progressively change, in order to maintain an orderly cell view. In particular, the radial and circumferential position co-ordinates of each alphanumeric text field sub-location are required to be adapted progressively from one cell position to the next in order that the texts in the respective field do not run into each other. In order to achieve this, the positions of each text field or numerical field or information sub-location in any cell may be mapped (defined) for each possible cell position. Alternatively, an algorithm may be used to define for each angular cell position, the respective positions of each text field or numerical field or sub-location. The sub-locations in any cell will thus deviate incrementally from the locations in a previous and subsequent cell.

A special additional measure may be taken to ensure the clarity of the displayed cell information for a user. In certain embodiments, the relative position of neighbouring sub-locations in a cell may be inverted as the represented cells cross an imaginary horizontal line which bisects the platform representation. For example, where one alphanumeric parameter field is displayed vertically above another (the vertical direction being seen as being vertically inside the plane of the display screen), the positions of the topmost and the lowermost parameters may advantageously be inverted (i.e. swapped) as any cell crosses an imaginary horizontal centre line through the image. Where three or more parameters are displayed at sub-locations above one another, the top and bottom parameter positions may be exchanged, while a parameter displayed in between the topmost and lowermost parameter may remain in its same relative position (the middle position).

FIG. 5 shows a view of a graphical representation of an arrangement comprising multiple stalls which is a milking platform arrangement. An operator may select a cell, such as cell number 15 using any appropriate input device, in order to reveal additional information concerning the corresponding stall. On doing so, the available video images 49 at the relevant milking point are displayed, together with current data concerning milking. Since milking has not commenced at stall 15 at the point in time which is illustrated, the milk yield remains at zero. For added clarity, from the point of view of an operator looking at a screen display, the cell 8 (in this case cell number 15) for which images are currently being shown may be highlighted in the display in a recognisably different shade of colour from the other cells. In the case which is illustrated, some data is overlaid on the video picture image and includes the milking point number (stall number) and also the animal number. Additional information may also be included combined with the video picture image. Selection by the user of other locations such as an entry area or a different milking point or teat cup attachment position would reveal whichever video images are available and which correspond to the selected item.

In the representation of the video images shown in FIG. 5, there can be seen the lower region of an animal at the stall and also parts of the stall construction as well as a robot arm carrying an instrument which may be a griper or cleaning device or perhaps a teat locating camera or such like. The robot arm is visible because it is present at the stall at the moment in time captured by the camera and shown in the video images 49.

The control and monitoring system according to the invention has been described with reference to various embodiments and examples. Accordingly, an operator of the animal installation receives an intuitive interface for controlling the complex system, which at the same time provides maximum information and natural images. This is provided in the form of a graphical representation of the system using shapes and symbols which directly represent physical units of the system, as well as video images. Clicking a symbol or image makes it possible to operate and/or get more information about the particular item. Advantageously, a rotary platform is graphically represented as a circle or annulus, which comprises segments which represent each stall or milking point and thereby gives an intuitive picture of the current status for each stall and for any surrounding robots and gates. The graphic representation of such a rotary platform rotates in order to always display the current state of the platform. Embodiments of the invention may typically use two-dimensional representations of the platform. An arrangement of multiple animal stalls is thereby displayed in a more realistic way than known devices and allows a more intuitive interaction with an operator. Additional variations and embodiments will be apparent to those in the art within the scope of the appended claims.

1-16. (canceled)

17. A control and monitoring system for an animal installation comprising automated animal treatment equipment, plural animal stalls arranged around a periphery of a rotary animal platform, and a camera system that includes a camera that takes images of an animal stall, said control and monitoring system comprising:
a computer control device (27) operatively linked to the rotary animal platform (14), to the automated animal treatment equipment (20, 22, 24), and to the camera system that includes the camera (21) that takes images of the animal stall;
a display device (28), the display device operatively linked to the control device, the display device including an interactive display and a user input element allowing an operator viewing the display to receive output information concerning processes taking place at the animal stalls and to intervene in the processes,
wherein the display device receives the output information from the control device and displays, on the display, the output information relating to a current status of operations at the animal stalls, where the animal platform is represented by an annular shape in which each animal stall (12) is represented by a cell (8), the cells displayed within the annular shape in a spatial layout corresponding to a layout of stalls as arranged around the periphery of the animal platform, the output information relating to the current status of the operations at each stall being represented within a corresponding cell, the cells each being selectable by the operator, using the input element, to display additional information concerning an individual selected cell in a separate window (4) and to display live video picture images showing the selected stall within the separate window, the live video picture images obtained from the camera, the picture images including any animal or part of any animal which is present at the selected stall and including any other physical entity or part of any physical entity which is also present at the selected stall,
wherein the display device displays each cell progressing about the displayed annular shape representing the platform in correspondence with a rotating movement of the platform, and
wherein the display further displays input channels, operable by the operator, to input control commands for commanding the animal treatment equipment.

18. The control and monitoring system according to claim 17, wherein the cells are selectable by the operator to display, at any point in time, the live video picture images in association with more than half of the animal stalls represented within the cells displayed within the annular shape representation of the platform.

19. The control and monitoring system according to claim 17, wherein,
the cells are selectable by the operator to display, at any point in time, the live video picture images in association with each animal stall represented within the cells displayed within the annular shape representation of the platform, and
within each animal stall is one automated animal treatment equipment that is a teat cup attachment device, the live video picture images including the teat cup attachment device and attachment of teat cups to teats of the animal during a teat cup attachment operation.

20. The control and monitoring system according to claim 17, wherein,
the cells are selectable by the operator to display, at any point in time, the live video picture images in association with each animal stall represented within the cells displayed within the annular shape representation of the platform, and
within each animal stall is one automated animal treatment equipment that is a animal milking device, the live video picture images including the animal milking device and milking of the animal during a milking operation.

21. The control and monitoring system according to claim 17, wherein the cells are selectable by the operator to display, at any point in time, the live video picture images of each animal stall, represented within the cells displayed within the annular shape representation of the platform, where animals enter the platform.

22. The control and monitoring system according to claim 17, wherein the cells are selectable by the operator to display, at any point in time, the live video picture images of each animal stall, represented within the cells displayed within the annular shape representation of the platform, where animals leave the platform.

23. The control and monitoring system according to claim 17, wherein the display device is further selectable by the operator to display, at any point in time, the live video picture images in association with a normally vacated stall location between an exit and an entrance point on the platform.

24. The control and monitoring system according to claim 17, wherein the display device is further selectable by the operator to display, in respect of a selected cell, a view showing the live video picture images combined with data which describes progress of an animal operation.

25. The control and monitoring system according to claim 17, wherein the display device is further selectable by the operator to display, in respect of a selected cell, a view showing the live video picture images combined with data which describes progress of milking of the animal.

26. The control and monitoring system according to claim 17, wherein the display device displays the separate window (4), with the additional information concerning an individual selected cell, superimposed over a part of the annular shape thereby covering at less some portions of some of the cells other than the individual selected cell.

27. A combination of the control and monitoring system according to claim 17 with the automated animal treatment equipment, the animals stalls arranged on the animal platform, and the camera system.

28. The combination of claim 27, wherein the camera is located outside of the platform and is directed towards the platform.

29. The combination of claim 27, wherein the camera system comprises plural video camera devices fixedly located about the rotating platform and directed towards the platform so as to capture the live video images from multiple stall positions around the platform.

30. The combination of claim 27, wherein the camera is located movably about the platform so as to gather the live video picture images from multiple stall positions around the platform.

31. The combination of claim 27, wherein the camera is positioned at a teat cup attachment location and a milking location so that the live video picture images include a teat cup attachment operation and a milking operation.
